(19) United States
(12) Patent Application Publication
(10) Pub. No.: US 2012/0295030 A1
(43) Pub. Date: Nov. 22, 2012

(54) HIGH DENSITY, HARD TIP ARRAYS

(75) Inventors: Albert K. HENNING, Palo Alto, CA (US); Raymond Roger Shile, Los Gatos, CA (US); Joseph S. Fragala, San Jose, CA (US); Nabil A. Amro, Prospect Heights, IL (US); Jason R. Haaheim, Chicago, IL (US)

(73) Assignee: NanoInk, Inc.

(21) Appl. No.: 13/473,533

(22) Filed: May 16, 2012

Related U.S. Application Data
(60) Provisional application No. 61/487,212, filed on May 17, 2011.

(51) Int. Cl. B05C 1/00; B05D 5/00; B32B 37/02; B32B 37/14; B32B 38/10

(52) U.S. Cl. 427/256; 156/60; 156/250; 156/272.2; 156/242; 118/200

(57) ABSTRACT

Improved high density, hard tip arrays for use in patterning are provided. An article comprises a handle chip; and a silicon nitride membrane bonded to at least a portion of the handle chip. The silicon nitride membrane comprises an array of a plurality of silicon nitride tips extending directly from a surface of the silicon nitride membrane. Another article comprises an elastomeric backing member; and an array of tips disposed on the elastomeric backing member. The tips of the array comprise a refractory material. Methods of making such articles are also provided.

### CROSS-REFERENCE TO RELATED APPLICATIONS

This application claims priority from U.S. Provisional Patent Application No. 61/487,212, filed May 17, 2011, which is hereby incorporated by reference in its entirety.

### BACKGROUND

In the context of stamp and tip-based microscale and nanoscale patterning, various modalities of tips (hard and soft, sharp and rounded, and permeable and impermeable) have been demonstrated over the last fifteen years approximately. The modalities have been described by a variety of names including, for example, microcontact printing, soft lithography, dip-pen-nanolithography, scanning probe contact printing, microstamp patterning, and the like. See, for example, U.S. Pat. Nos. 6,635,311; 6,827,979; and 7,344,756.

In some cases, these tips have been intended to achieve the goal of large-area fabrication of microstructures and nanostructures, without the requirement of a conventional photolithographic mask. Recently, hard silicon tips with a soft backing have been proposed as a preferred means to accomplish this goal. See, for example, Shim, et al., “Hard tip, soft-spring lithography”, Nature, (469) pp 516-520, 2010 and also WO 2010/141,836 (Mirkin et. al., Northwestern Univ.). However, in the context of manufacturable and reliable tip-based patterning, silicon suffers as a tip material because, for example, its crystalline structure leads to fracture at relative low macroscale forces for the lithographic system—forces which can occur even with a soft backing in some embodiments, at least. Silicon tips also experience undesired wear over extended use and become duller. In addition, use of some tip materials of interest may cause fabrication problems. Also, some tips may fall off of their supporting structure.

A need exists for better tip systems and methods for making the same.

### SUMMARY

Embodiments described herein include articles, methods of making, and methods of using. Kits can also be provided.

For example, one embodiment provides an article comprising: at least one silicon nitride tip array, wherein the tip array is substantially free of cantilevers, at least one handle chip, wherein the tip array is bonded to the at least one handle chip.

Another embodiment provides a method comprising: preparing a silicon nitride tip array which is substantially free of cantilevers, preparing a handle wafer, and bonding the tip array to the handle wafer to form a bonded tip array.

Another embodiment provides an article comprising: at least one elastomeric tip array, wherein the tips of the tip array comprise a surface layer of refractory material.

Another embodiment provides a method comprising: providing at least one mold for a tip array comprising a plurality of mold regions for tips, coating the mold regions for tips with a refractory material, filling the mold regions for tips with an elastomeric material so that elastomeric material is in contact with the refractory material and forms at least one elastomeric tip array, wherein the tips of the tip array comprise a surface layer of refractory material upon removal from the mold.

Elastomeric material, such as a polysiloxane like PDMS (polydimethylsiloxane) also can be a precursor to an elastomeric material including a precursor to a polysiloxane or PDMS.

Another embodiment provides a method comprising: providing the silicon nitride tip arrays as described herein, disposing at least one patterning composition on the tip array, transferring the composition from the tip array to a substrate surface. For example, biological materials like proteins and nucleic acids can be patterned.

Another embodiment provides a method comprising: providing an elastomeric tip array comprising refractory material, as described herein, disposing at least one patterning composition on the tip array, transferring the composition from the tip array to a substrate surface. Again, for example, biological materials like proteins and nucleic acids can be patterned.

In addition, embodiments described herein include modalities of microscale and nanoscale patterning, using either: (A) silicon nitride membranes, with high-density arrays of intentionally either sharp or rounded tips silicon nitride, with a soft/compliant, for example, PDMS backing for contact force management; or, (B) high-density arrays of refractory metal tips (Cr, for example), again backed by, for example, PDMS, Covering an area of approximately 1 cm², arrays built with these other modalities can be large enough to be effective for manufacturing. They can be hard enough to hold their shape reliably for many cycles. The close spacing of the tips can offer high speed patterning compared to a lower density array. In addition, the shape of the tips in these arrays can be controlled to a high degree, offering high-performance. The hard tips can resist deformation leading to higher fidelity of small printed spots. Compared to soft polymer tips, the spot size can be independent of tip force leading to much more uniform patterns across the printed area. Compared to tips on cantilevers, the tip density can be higher resulting in faster printing of dense patterns. When combined with a precision position system, a lithographic system based on these arrays can achieve at least some of and in some cases many of the requirements. For example, the tips can be relatively stable on their support structure and do not fall off.

### BRIEF DESCRIPTION OF THE DRAWINGS

FIGS. 1A-1D illustrate an embodiment for a SiN membrane array. FIG. 1A is a top plan view of the array; FIG. 1B is a top plan magnified view of the portion of the array labeled “Detail A” in FIG. 1A; FIG. 1C is a cross-sectional view of the array taken along the line X-X of FIG. 1A; and FIG. 1D is a cross-sectional magnified view of the portion of the array labeled “Detail B” in FIG. 1C.

FIG. 2 illustrates an embodiment for a SiN membrane array (higher magnification of a square array).

FIG. 3 illustrates an embodiment for a SiN membrane array (lower magnification of a square array).

FIG. 4 illustrates an embodiment for a SiN membrane array (perspective view of entire tip array including handle and hole region).

FIGS. 5A-5D illustrate an embodiment for the refractory tip array, FIG. 5A being a top plan view of the array, FIG. 5B being a top plan magnified view of the portion of the array laveled “Detail C” in FIG. 5A, FIG. 5C being a cross-sectional view of the array taken along the line Y-Y of FIG. 5A, and FIG. 5D being a cross-sectional magnified view of the portion of the array labeled “Detail D” in FIG. 5C.

FIG. 6 illustrates an embodiment for a refractory tip array.

FIG. 7 illustrates an embodiment for a refractor tip array.

FIG. 8 illustrates an embodiment for a refractory array.

FIG. 9A shows for one embodiment an optical image of a SiN HD tip membrane having perforations, and FIG. 9B also shows an embodiment for a top plan view of a SiN HD tip membrane having perforations.

FIG. 10 shows for one embodiment a process for mounting a SiN HD tip membrane on an elastomeric backing member.

FIG. 11 shows for one embodiment a top plan magnified view of a portion of a SiN HD tip membrane having perforations.

FIGS. 12A-12F show various possible configurations of the perforations in a SiN HD tip membrane.

FIG. 13 shows for one embodiment a side view of an SiN HD tip membrane disposed on an elastomeric backing member (in this case, PDMS).

FIG. 14 shows for one embodiment SEM images of various portions of a patterned substrate, demonstrating the consistency of patterning at the four corners of the substrate.

FIG. 15 shows for one embodiment SEM images of various portions of a patterned substrate, demonstrating the consistency of patterning at the four corners of the substrate.

FIG. 16A shows for one embodiment a process for filling a refractory material (in this case, Cr) in a mold (in this case, Si), showing both partial filling of the mold recesses (on the bottom left), and complete filling of the mold recesses (on the bottom right), and FIG. 16B shows top and top perspective views of non-continuous islands of refractory material tips on a mold.

FIGS. 17A-17C show for one embodiment a process for forming an array of refractory material tips (in this case, Cr tips) on an elastomeric backing member (in this case, a PDMS backing member), FIG. 17A showing the step of pouring a liquid PDMS precursor into a container to surround a Cr/Si mold and a spacer, FIG. 17B showing a curing step, FIG. 17C showing a step of disposing the cured PDMS backing member and Cr/Si mold into an etching solution to remove the Si, FIG. 17D showing the PDMS backing member and Cr tips after etching, and FIG. 17E showing the Cr tips disposed on the PDMS backing member after dicing.

### DETAILED DESCRIPTION

### Introduction

All references cited herein are incorporated by reference in their entirety.

Priority U.S. Provisional Patent Application No. 61/487,212, filed May 17, 2011, is hereby incorporated by reference in its entirety including the claims and drawings and examples.

The following references can be used in the practice of the various embodiments described herein including patterning methods and compositions:
1. Wilbur, et al., “Microcontact printing of self-assembled monolayers: applications in microfabrication.” Nanotechnology 7, pp. 452-457 (1996).
2. Biebuyck, et al., “Lithography beyond light: Microcontact printing with monolayer resists.” IBM J. Res. Dev. 41(1/2), pp. 159170 (1997).
3. Xia et al., “Soft lithography.” Ann. Rev. Mat. Sci. 28, pp. 153-184 (1998).
4. Wang, et al., “Scanning Probe Contact Printing.” Langmuir 19(21), pp. 8951-8955 (2003).
5. Zou, et al., “Conductivity-based contact sensing for probe arrays in dip-pen nanolithography.” Appl. Phys. Lett. 83(3), pp. 581583 (2003).
6. Liu, et al., “Scanning probe microscopy probes and methods.” U.S. Pat. No. 7,081,624 (25 Jul. 2006).
7. Mirkin, et al., “Method for scanning probe contact printing.” U.S. Pat. No. 7,344,756 (18 Mar. 2008).
8. Li, et al., “Pneumatically actuated elastomeric device for nanoscale surface patterning.” Appl. Phys. Lett. 91(2), pp. 023109-1ff (2007).
9. Xia, et al., “Reduction in the Size of Features of Patterned SAMs Generated by Microcontact Printing with Mechanical Compression of the Stamp,” Adv. Mater. 7, pp. 471-473 (1995).
10. A. Kumar and G. M. Whitesides, “Formation of microstamped patterns on surfaces and derivative articles.” U.S. Pat. No. 5,512,131 (30 Apr. 1996).
11. G. M. Whitesides, et al., “Microcontact printing on surfaces and derivative articles.” U.S. Pat. No. 6,180,239 (30 Jan. 2001).
12. Hong, et al., “A Nanoplotter with Both Parallel and Serial Writing Capabilities.” Science 288(5472), pp. 1808-1811 (9 Jun. 2000).
13. Mirkin, et al., “Multiscale Soft Pen Lithography.” U.S. Patent Provisional Application, 27 Jun. 2008.
14. Ginger, et al., “The evolution of dip-pen nanolithography.” Angew. Chem. Int. Ed. 43, pp. 30-45 (2004).
15. Zhang, et al., “Dip pen nanolithography stamp tip,” Nano Lett 4(9), pp. 1649-1655 (2004).
16. Shim, et al., “Hard tip, soft-spring lithography”, Nature, (469) pp 516-520, 2010.
17. Hong, et al., “A Micromachined elastomeric tip array for contact printing with variable dot size and density”, Journal of Micromechanics and Microengineering, 1815003 (2008).

Transfer of inks from tips, which can be carried out with use of the tip arrays described herein, are described in technical literature including, for example, U.S. Pat. Nos. 6,635,311; 6,827,979; 7,102,655; 7,223,438; 7,273,636; 7,291,284; 7,326,380; 7,344,756; and 7,361,310. A wide variety of inks can be patterned including inorganic, organic, biological, low molecular weight, polymeric, particulate, and nanostructured materials.

Embodiments described herein can provide hard tip arrays. In one embodiment, hard silicon nitride tip arrays are prepared. In another embodiment, tip arrays comprising surfaces of refractory materials such as chromium can be prepared. In each case, the disadvantage of using silicon tips can be avoided. In particular, silicon tips can be substantially or totally excluded from the tip arrays.

In one embodiment, the tip array is totally free of cantilevers. In one embodiment, the tip array is totally free of silicon tips.

### SiN Membrane Arrays

One embodiment provides an article comprising: at least one silicon nitride tip array, wherein the tip array is substantially free of cantilevers, at least one handle chip, wherein the tip array is bonded to the at least one handle chip. In one embodiment, the silicon nitride tip array comprises low stress silicon nitride.

In one embodiment, an article comprises a handle chip; and a silicon nitride membrane bonded to at least a portion of the handle chip. The silicon nitride membrane comprises an array of a plurality of silicon nitride tips extending directly from a surface of the silicon nitride membrane. The silicon nitride membrane can be a monolithic integrated structures wherein the tips are a part of the support structure. This can provide added stability so the tips do not fall off of the support structure.

Handle chips are known in the art. See, for example, US Patent Publication 2011/0268883.

The tips can be adapted to provide for disposing an ink composition on the tip and then transferring the ink from the tip to a substrate. In one embodiment, the tip array is a nanoscopic tip array. If desired, the tips can be surface coated.

Bonding methods are known in the art. In one embodiment, the tip array is anodically bonded to the at least one handle chip.

Materials for making a handle chip are known in the art. In one embodiment, the handle chip is a pyrex handle chip. The handle chip can also be called a support.

In one embodiment, the handle chip comprises at least one hole region. In one embodiment, furthermore, the handle chip comprises at least one hole region, and an elastomeric backing layer for the tip array disposed in the hole region. In one embodiment, for example, the handle chip comprises at least one hole region, and a polysiloxane backing layer for the tip array disposed in the hole region.

In one embodiment, the array of tips is characterized by a tip density of at least 100,000 per square cm. In one embodiment, the array of tips is characterized by a tip density of at least 250,000 per square cm. In one embodiment, the array of tips is characterized by a tip density of at least 1,000,000 per square cm.

In one embodiment, the tips of the tip array are characterized by a tip radius of about 250 nm or less. In one embodiment, the tips of the tip array are characterized by a tip radius of about 100 nm or less. In one embodiment, the tips of the tip array are characterized by a tip radius of about 50 nm or less. In one embodiment, the tips of the tip array are characterized by a tip radius of about 20 nm or less.

In one embodiment, the tip array has an area of at least one square cm. In another embodiment, the tip array has an area of less than one square cm. In one embodiment, the tip array is characterized by a tip spacing of about 1 micron to about 100 microns. In one embodiment, the tip array is characterized by a tip spacing of about 5 microns to about 50 microns. In one embodiment, the tip array is characterized by a tip spacing of about 10 microns to about 30 microns.

In one embodiment, the tip array has a thickness of about 100 nm to about one micron. In one embodiment, the tip array has a thickness of about 400 nm to about 800 nm. In one embodiment, the thickness is about 600 nm.

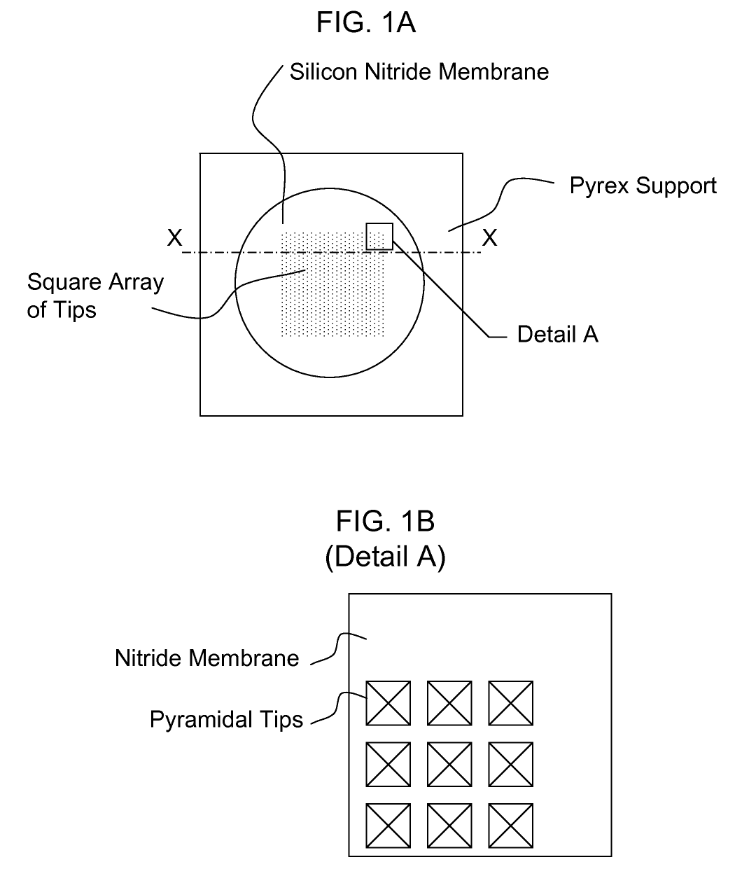

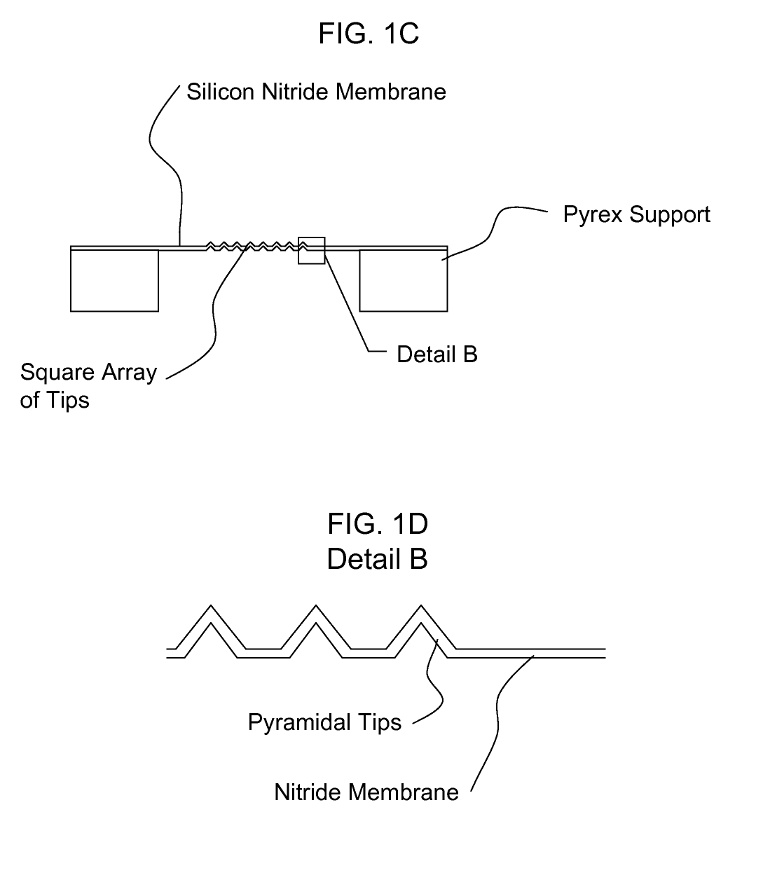

FIGS. 1A-1D illustrate an embodiment. In FIG. 1A, a top view is shown for the silicon nitride membrane and tip array with a square array of tips. Also shown is the pyrex support including the hole region. In FIG. 1B, an expanded form of the tip array region is illustrated, showing pyramidal tips. In FIG. 1C, a side, cross sectional view is shown. In FIG. 1D, an expanded view of the tip array region is illustrated.

In one embodiment, the tip array is totally free of cantilevers. In one embodiment, the tip array is totally free of silicon tips.

### Method of Making SiN Arrays

One embodiment provides a method comprising: preparing a silicon nitride tip array which is substantially free of cantilevers, preparing a handle wafer, and bonding the tip array to the handle wafer to form an bonded tip array.

In one embodiment, the embodiment further comprises the step of dicing the bonded tip array.

In one embodiment, the bonding is an anodical bonding.

In one embodiment, the handle wafer is a pyrex handle wafer.

In one embodiment, the handle wafer comprises at least one hole region.

In one embodiment, the tip array is totally free of cantilevers.

In one embodiment, the tip array is totally free of silicon tips.

In one embodiment, the silicon nitride is low stress silicon nitride.

In one embodiment, the tip array is a square tip array.

In one embodiment, the embodiment further comprises the step of disposing an elastomeric backing in the hole region.

In one embodiment, a method comprises preparing a silicon nitride membrane comprising an array of a plurality of silicon nitride tips extending directly from a surface of the silicon nitride membrane; preparing a handle wafer; and bonding the silicon nitride membrane to at least a portion of the handle wafer to form an bonded tip array.

In one embodiment, the handle wafer comprises at least one hole region, a portion of the silicon nitride membrane extends across the hole region, and the method further comprises the step of disposing an elastomeric backing member in the hole region.

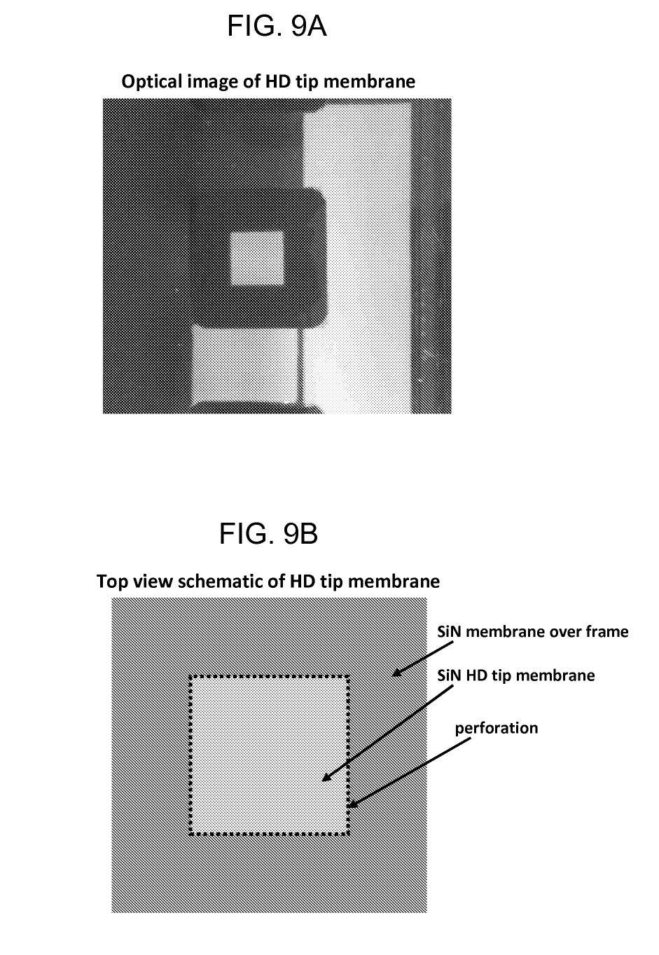

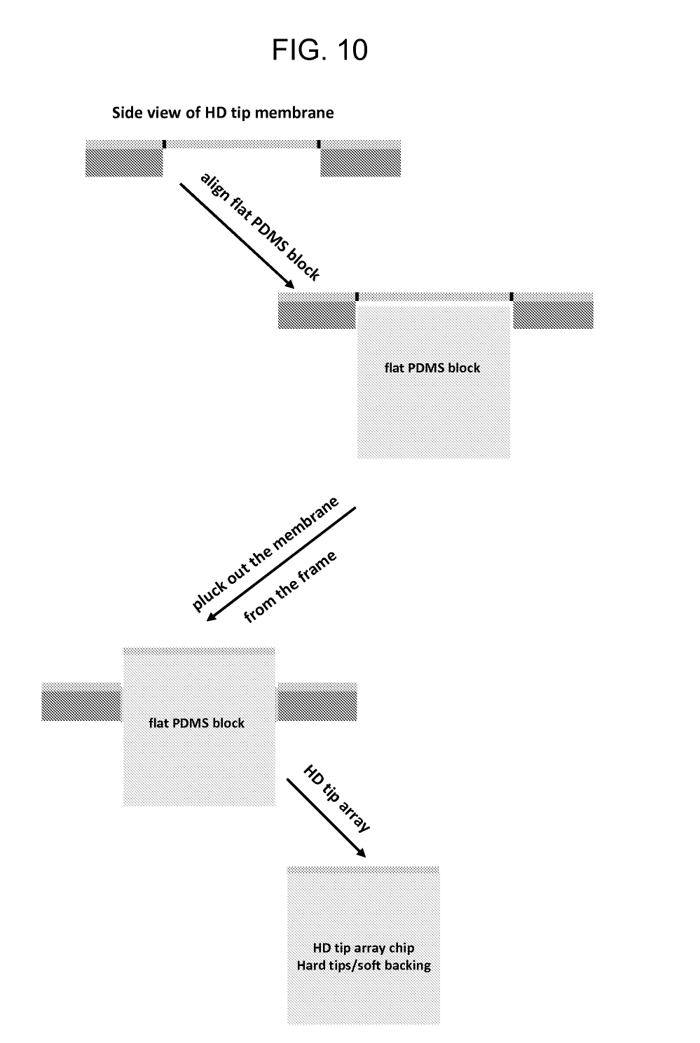

In one embodiment, the handle wafer comprises at least one hole region, a portion of the silicon nitride membrane extends across the hole region, the silicon nitride membrane comprises a plurality of perforations surrounding at least part of the portion of the silicon nitride membrane that extends across the hole region, and the method further comprises disposing an elastomeric backing member in the hole region, and pressing the elastomeric backing member against a back surface of the silicon nitride membrane such that the part of the silicon nitride membrane surrounded by the plurality of perforations separates from a remainder of the silicon nitride membrane and attaches to the elastomeric backing member. An example of this embodiment is illustrated in FIGS. 9A, 9B, and 10.

FIG. 9A is an optical image of a SiN HD tip membrane having perforations, and FIG. 9B is a top plan view of a SiN HD tip membrane having perforations.

The top image of FIG. 10 illustrates a silicon nitride membrane comprising an array of silicon nitride tips extending from a surface (the top surface in FIG. 10). The SiN membrane is attached to a handle wafer (such as a Si handle wafer) that has a hole region, such that a portion of the SiN membrane extends across the hole region. The SiN membrane includes perforations that surround the portion of the SiN membrane that extends across the hole region of the handle wafer. A flat elastomeric backing member (in this case, a PDMS block) disposed in the hole region of the handle wafer and aligned with the perforations, as shown in the second image from the top in FIG. 10. Next, the backing member is pressed against the back surface of the SiN membrane (the bottom surface in FIG. 10) such that the part of the SiN membrane surrounded by the perforations separates from a remainder of the SiN membrane, as shown in the third image from the top in FIG. 10. The SiN membrane thus attaches to the backing member, as shown in the bottom image of FIG. 10.

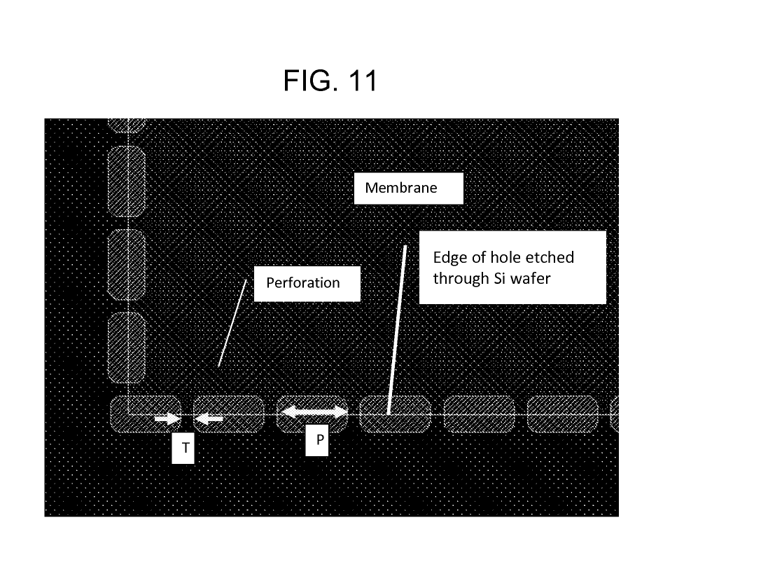

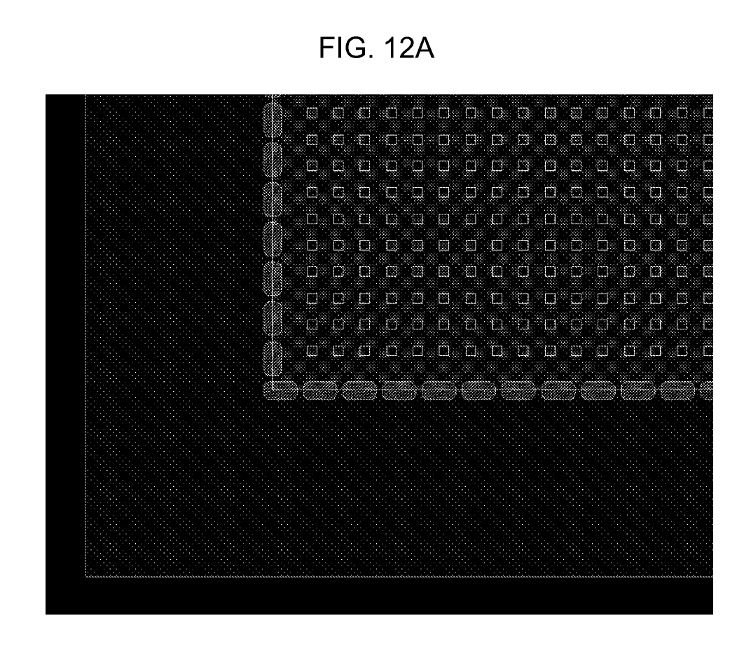

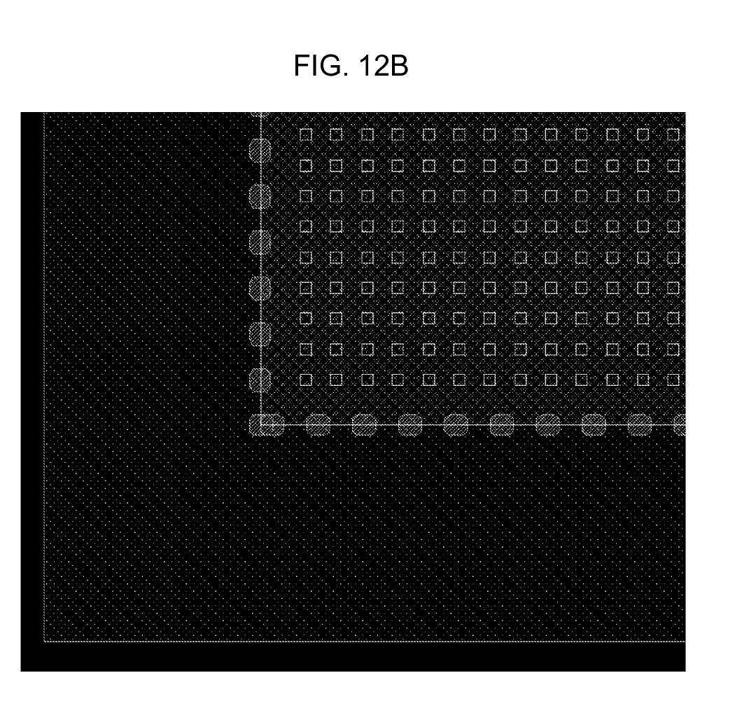

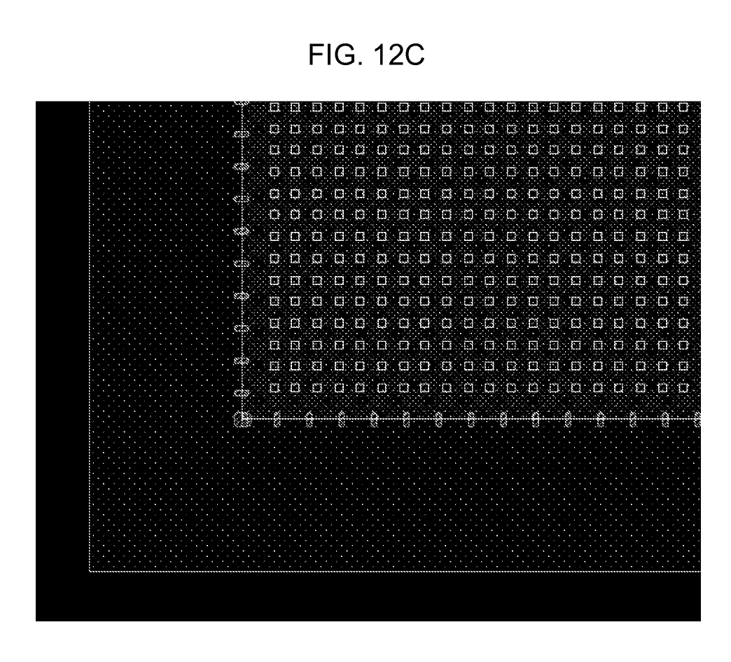

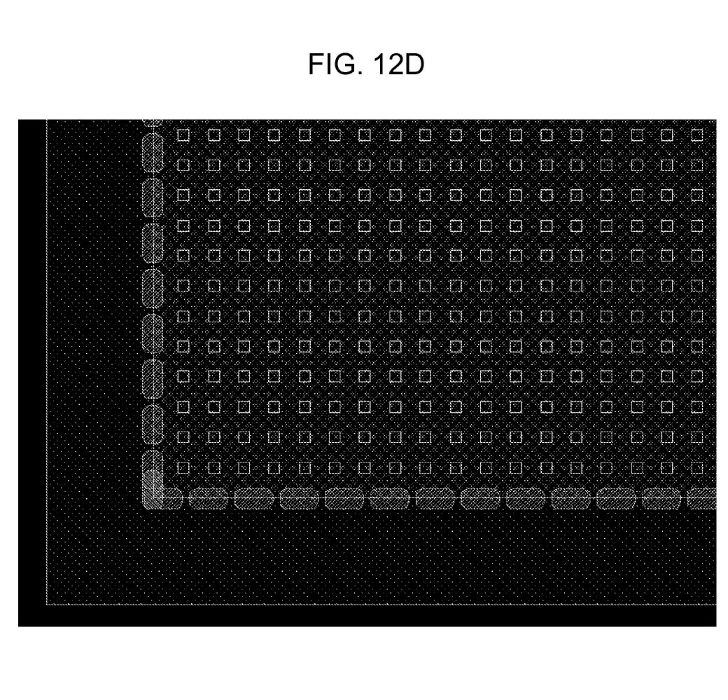

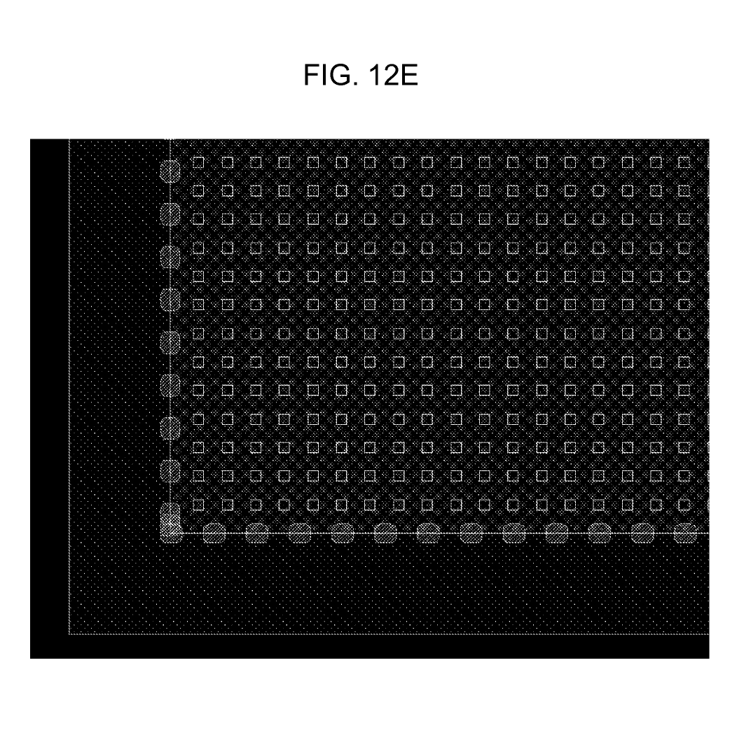

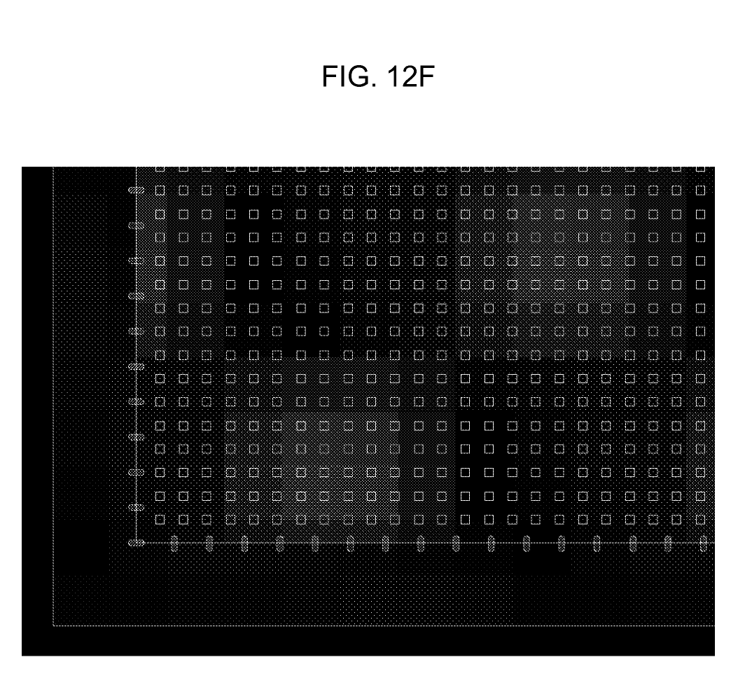

FIG. 11 is a top plan magnified view of a portion of a SiN HD tip membrane having perforations. A variety of possible perforation designs are possible. For example, length P of the perforations and distance between perforations T, may be set as indicated in Table 1 below, and shown in FIGS. 12A-12F.

TABLE 1

| FIG. | Tab, T(μ) | Perforation, P(μ) |
|---|---|---|
| 12A | 10 | 50 |
| 12B | 30 | 30 |
| 12C | 50 | 10 |
| 12D | 20 | 100 |
| 12E | 60 | 60 |
| 12F | 100 | 20 |

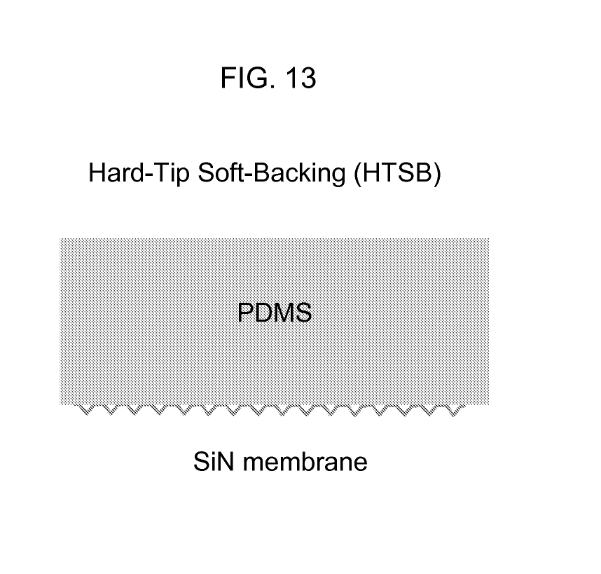

FIG. 13 shows an example of a SiN membrane HD tip array over a PDMS backing member that can be created using the above methods.

### Applications

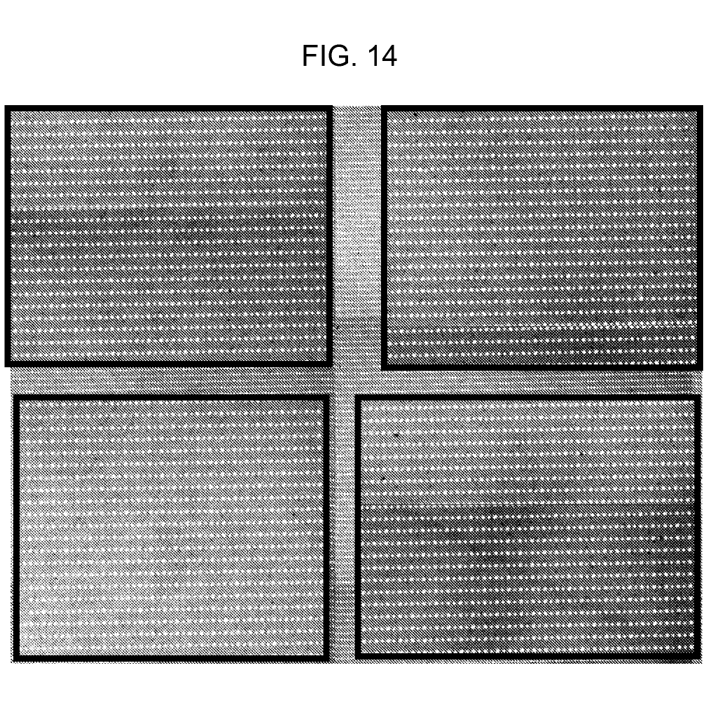

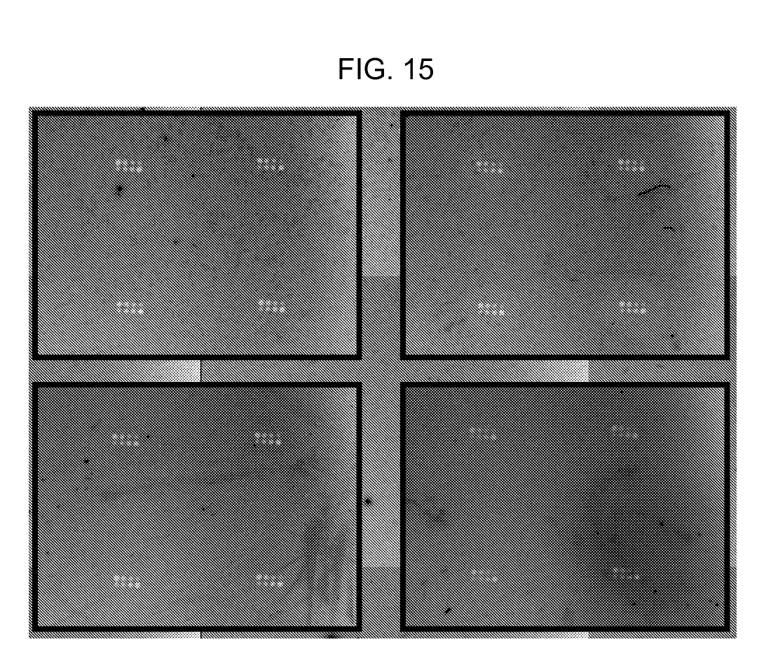

The tip arrays can be used for patterning and transfer of ink compositions from the tip to a surface. For example, FIGS. 14 and 15 show SEM images of various portions of patterned substrates formed using a SiN membrane HD tip array on a PDMS backing member, demonstrating the consistency of patterning at the four corners of the substrates.

### Refractory Tip Arrays

One embodiment, in addition, provides an article comprising: at least one elastomeric tip array, wherein the tips of the tip array comprise a surface layer of refractory material. Refractory materials and metals are known in the art. In one embodiment, the refractory material has a melting point higher than 2,000° C., or alternatively, higher than 4,000° C.

In one embodiment, an article comprises an elastomeric backing member; and an array of tips disposed on the elastomeric backing member. The tips of the array comprise a refractory material.

In one embodiment, the refractory material is a refractory metal.

In one embodiment, the refractory material is Nb, Mo, Ta, W, Ru, Ti, V, Cr, Zr, Ru, Rh, Hf, Os, or Ir.

In one embodiment, the refractory material is Nb, Mo, Ta, W, or Ru.

In one embodiment, the refractory material is Cr.

In one embodiment, the refractory material is W, diamond, a carbide, or a boride.

In one embodiment, the elastomeric tip array is a polysiloxane tip array.

In one embodiment, the tips of the elastomeric tip array are nanoscopic tips.

In one embodiment, the tips of the refractory material form non-continuous islands, with each island covering each elastomer tip.

In one embodiment, the tip array is a square array.

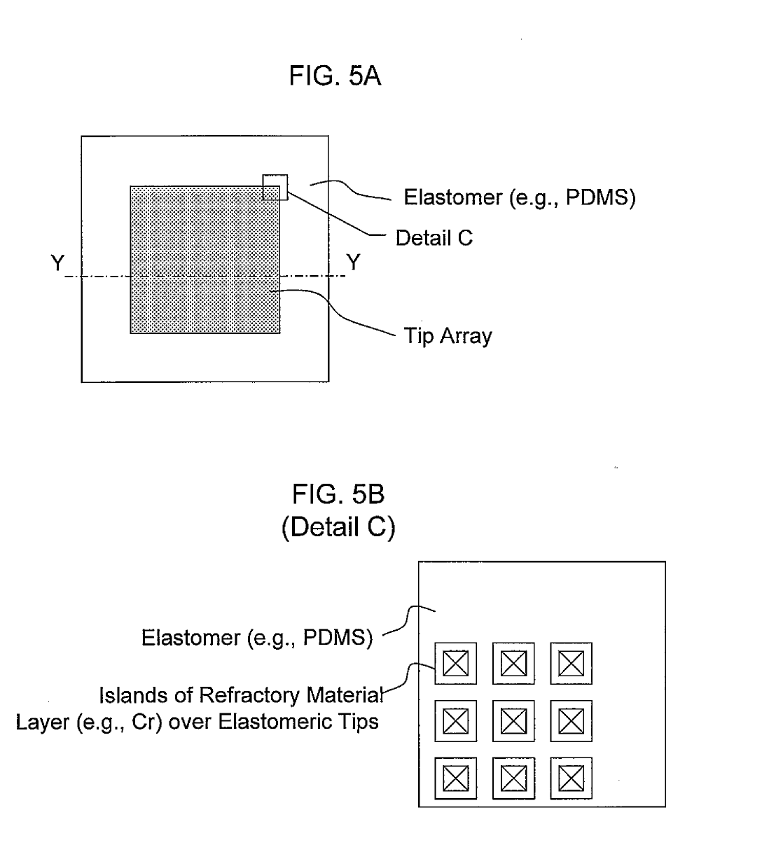

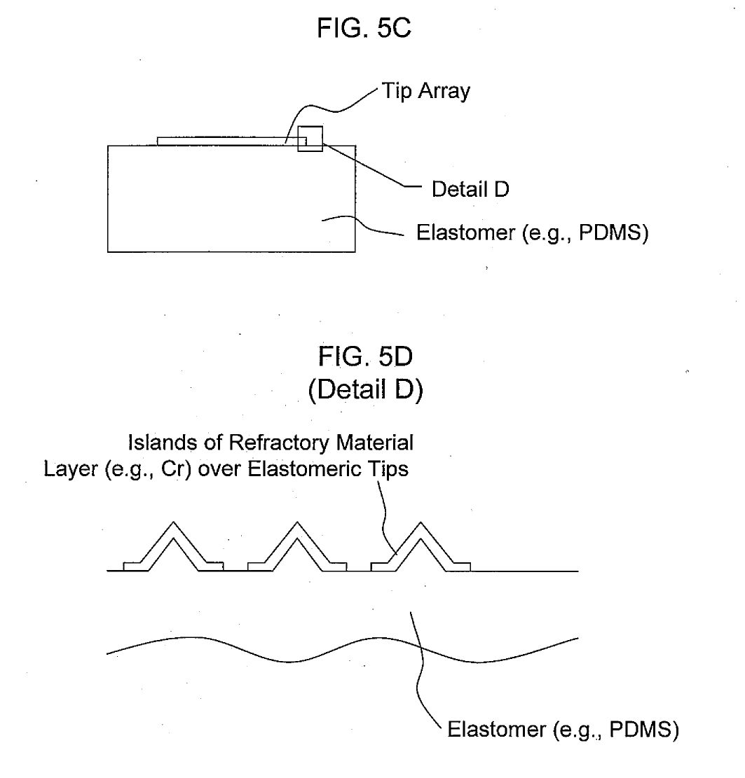

FIGS. 5A-5D illustrate additional embodiments for use of refractory materials and islands of refractory materials. The elastomer tips can be a monolithic integrated structures wherein the tips are a part of the support structure. In the array, the elastomer backing material can comprise elastomer tips integral with elastomer backing. This can provide added stability so the tips do not fall off of the support structure.

### Method of Making Refractory Tip Arrays

Another embodiment provides a method comprising: providing at least one mold for a tip array comprising a plurality of mold regions for tips, coating the mold regions for tips with a refractory material, filling the mold regions for tips with an elastomeric material so that elastomeric material is in contact with the refractory material and forms at least one elastomeric tip array, wherein the tips of the tip array comprise a surface layer of refractory material upon removal from the mold.

In one embodiment, the elastomer material is curable to form an elastomeric material.

In one embodiment, the elastomer material is a siloxane.

In one embodiment, the refractory material is a refractory metal.

In one embodiment, the refractory material is Nb, Mo, Ta, W, Ru, Ti, V, Cr, Zr, Ru, Rh, Hf, Os, or Ir.

In one embodiment, the refractory material is Nb, Mo, Ta, W, or Ru.

In one embodiment, the refractory material is Cr.

In one embodiment, the refractory material is W, diamond, a carbide, or a boride.

In one embodiment, the tips of the refractory material are patterned so as to form non-continuous islands, with each island covering each elastomer tip. In one embodiment, the refractory material is coated to a thickness of about 250 nm to about 750 nm, or about 300 nm to about 500 nm, or about 400 nm.

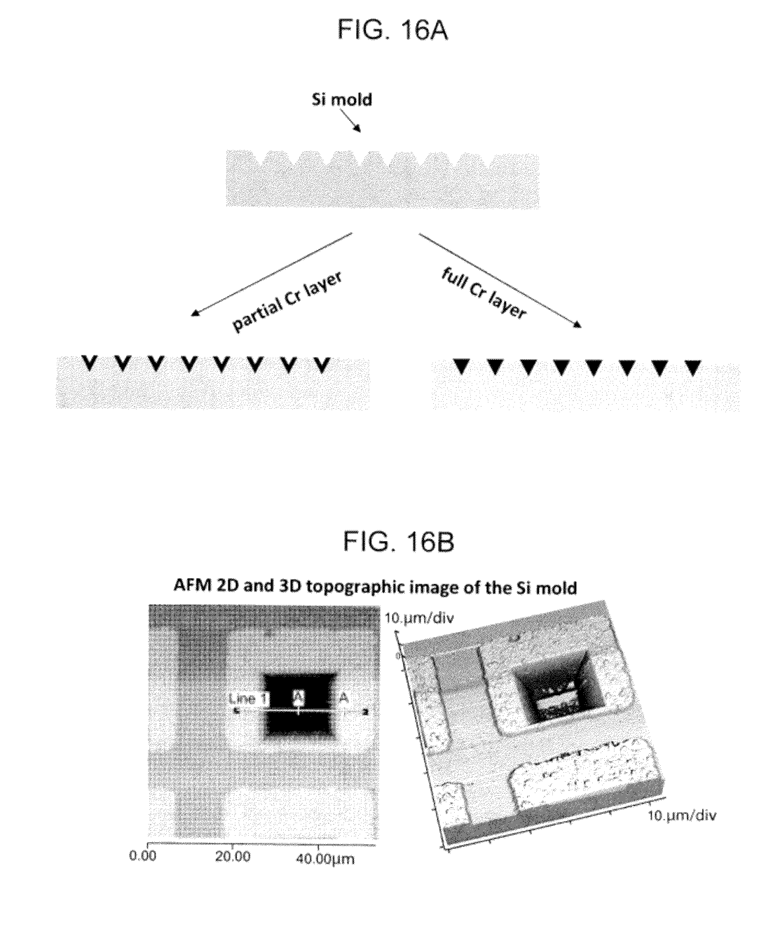

FIG. 16A shows a process for filling a refractory material (in this case, Cr) in a mold (in this case, Si), showing both partial filling of the mold recesses (on the bottom left), and complete filling of the mold recesses (on the bottom right). FIG. 16B shows top and top perspective views of non-continuous islands of refractory material tips on a mold (in this case, Cr tips formed in a Si mold).

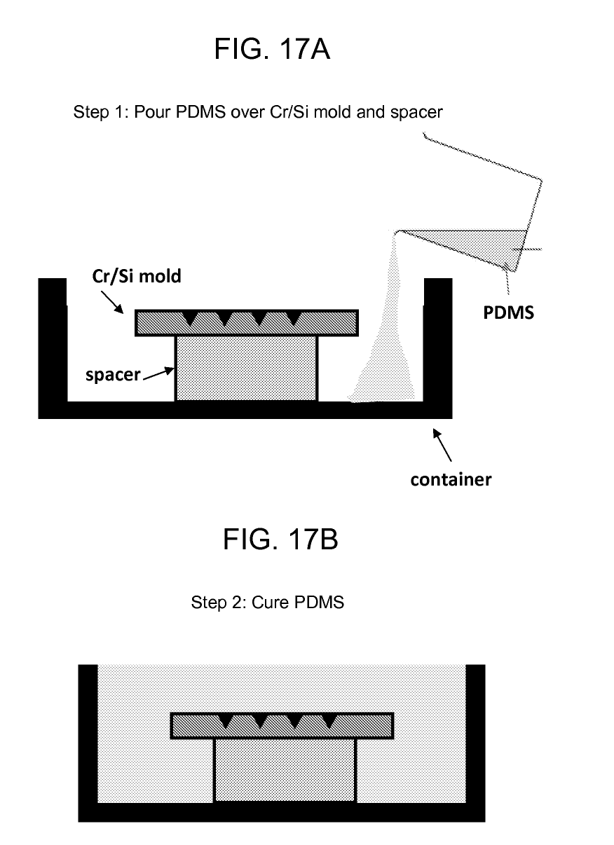

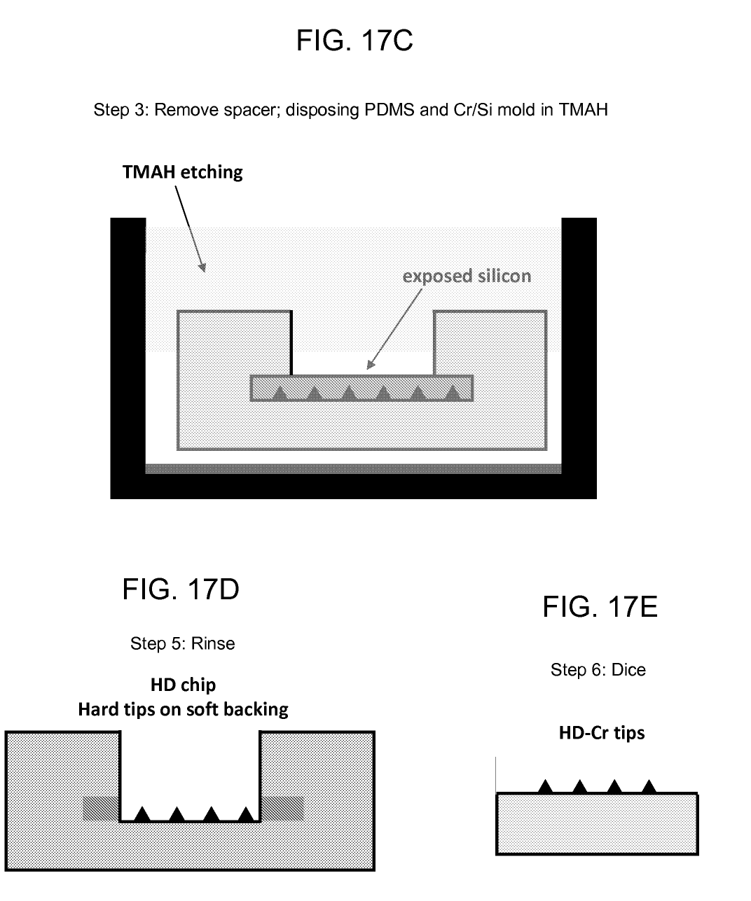

FIGS. 17A-17C show a process for forming an array of refractory material tips (in this case, Cr tips) on an elastomeric backing member (in this case, a PDMS backing member). FIG. 17A shows the step of pouring a liquid PDMS precursor into a container to surround a Cr/Si mold and a spacer. FIG. 17B showing a curing step. FIG. 17C shows a step of disposing the cured PDMS backing member and Cr/Si mold into an etching solution (TMAH) to remove the Si. FIG. 17D shows the PDMS backing member and Cr tips after etching. FIG. 17E shows the Cr tips disposed on the PDMS backing member after dicing.

### EXAMPLES

### Example 1

### Method of Making SiN Membranes

1. Grow 1500 Å silicon oxide

2. Pattern tip mold squares

3. Etch oxide

4. Etch Si tip molds in KOH

5. Grow 5000 Å sharpening oxide (optional)

6. Pattern and etch sharpening oxide (optional)

7. Deposit 600 nm low stress silicon nitride

8. Oxidize silicon nitride

9. Remove nitride from side opposite tip molds

10. Prep Pyrex wafer with through holes (using DRIE in AOE or HF etch or impact grinding or patterned powder blasting)

11. Clean Si and Pyrex wafers

12. Align and anodically bond nitride wafer to Pyrex wafer

13. Dice

14. Etch silicon mold wafer in TMAH or KOH

15. Rinse in DI water and dry

16. Add PDMS to backside of diaphragm (in the hole drilled into Pyrex) to add strength and stiffness to diaphragm (optional)

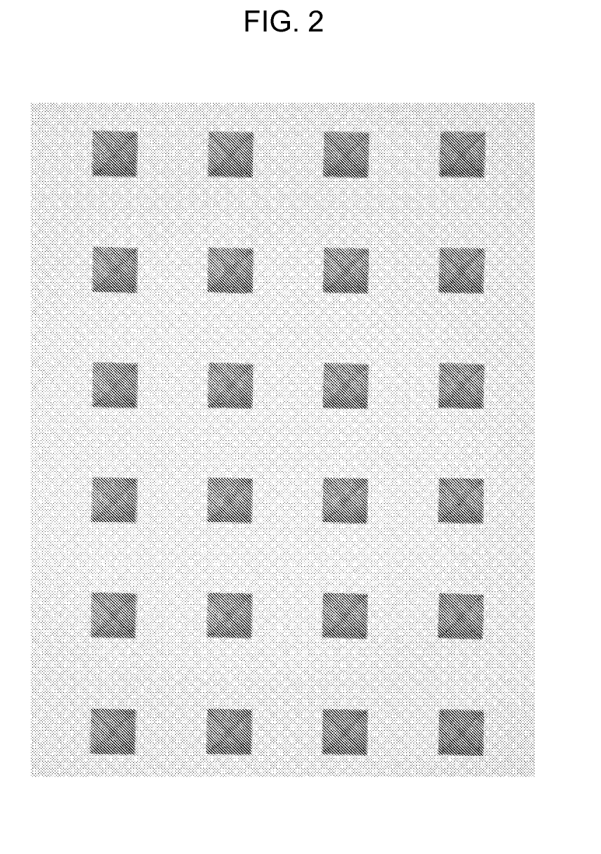

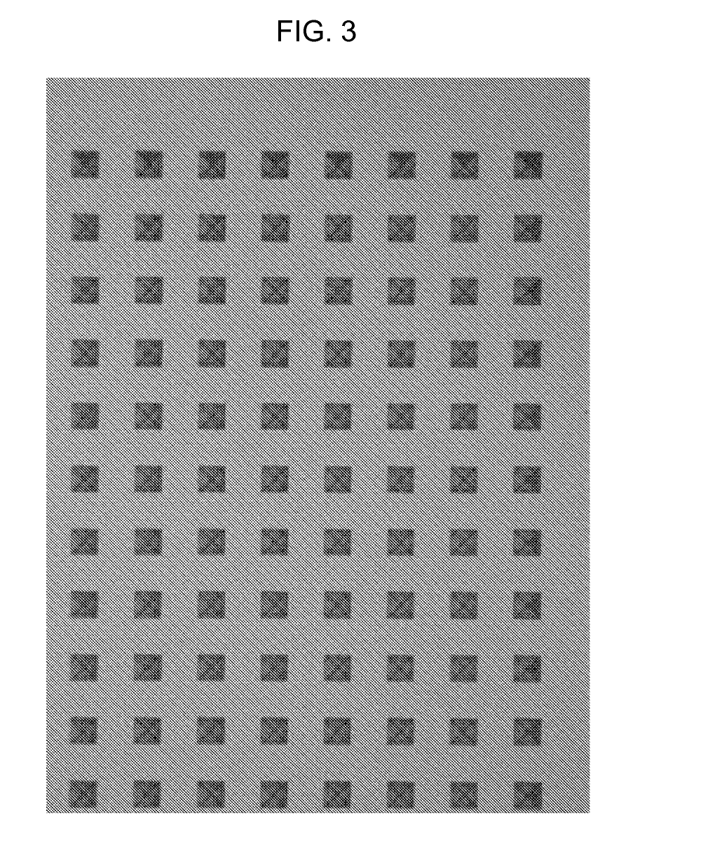

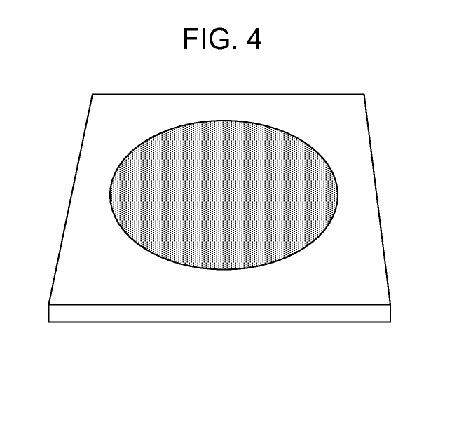

FIGS. 2-4 show photographs of an embodiment for the SiN array.

### Example 2

### Method of Making Refractory Tips

Procedure for HD tips, Hard tips/soft backing

1. Grow 1500 Å silicon oxide

2. Pattern tip mold squares

3. Etch oxide

4. Etch Si tip molds in KOH

5. Grow 5000 Å sharpening oxide (optional)

6. Pattern and etch sharpening oxide (optional)

7. Deposit antistiction film (optional)

8. Sputter 4000 Åtip material (Cr or other hard material eg Ir, Os, W, Diamond, Carbides, Borides, etc.)

9. Pattern to etch Cr into individual squares in and around each tip mold, but not interconnected

10. Strip resist

11. Dice into pieces

12. Clean

13. Put into mold and cast PDMS or other polymer

There are two options for PDMS steps (14a and 14b):

14a.
Cast 1: 10 ratio Siliguard Dupont PDMS on FDTS-treated silicon area (chrome is NOT FDTS-treated).
Cure for about 2 hrs at 70 deg C., or overnight
Peel PDMS from mold with Cr tips attached to PDMS block.
Use optical/AFM inspection to verify integrity of Cr tips

14b.
Cast 1: 10 ratio Siliguard Dupont PDMS on NON-FDTS-treated silicon; this should happen immediately after plasma cleaning between 1-5 minutes
Cure for about 2 hrs at 70 deg C., or overnight
Protect PDMS with photoresist that does not dissolve, etch, or melt in the silicon etch-resist solution
Remove silicon using etch-resist (such as TMAH), overnight, warm or boiling
Verify etch end-point detection (want to stop just as getting to PDMS and chrome, but not too much after) using one of or a combination of LFM, XPS, or optical inspection.

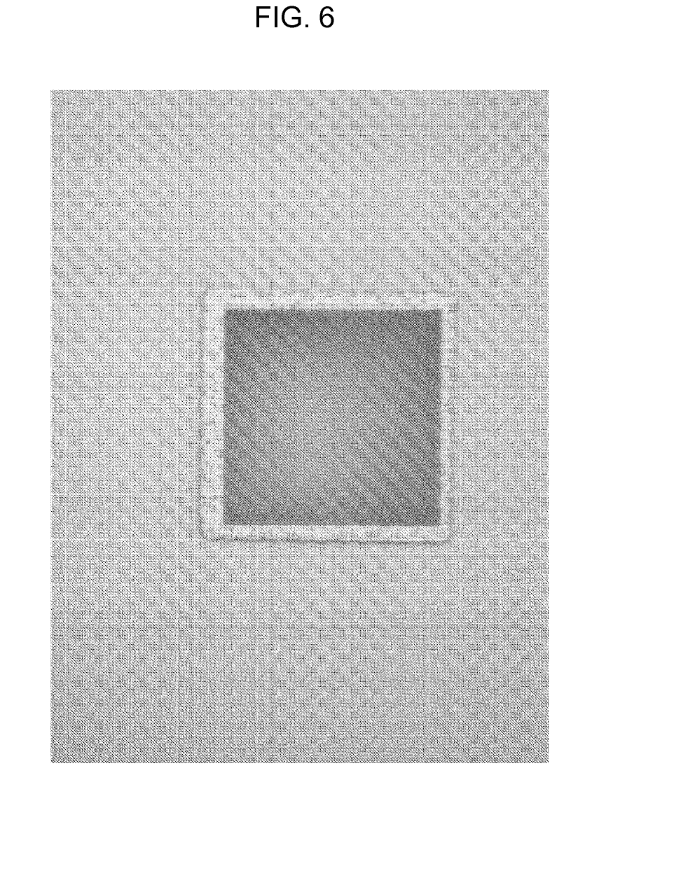

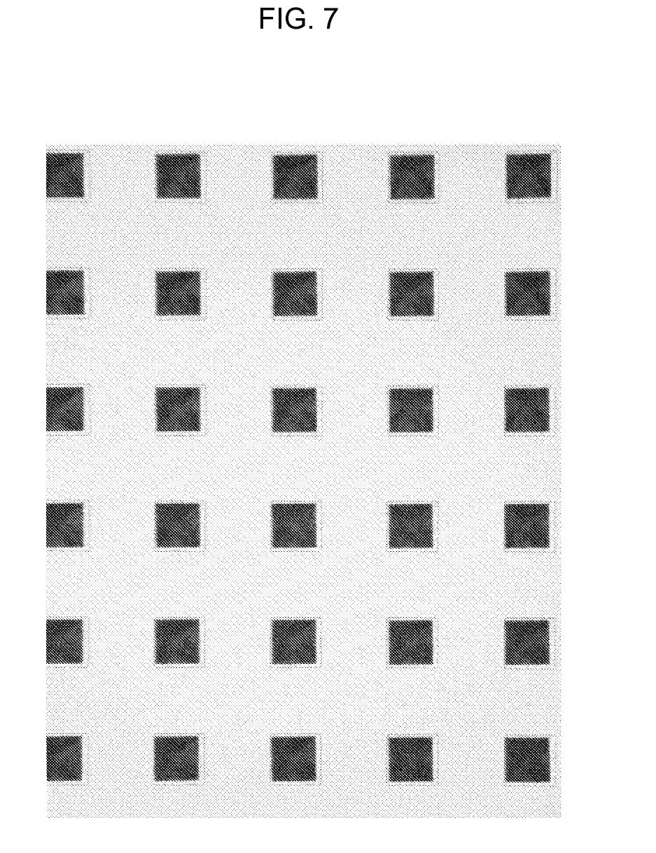

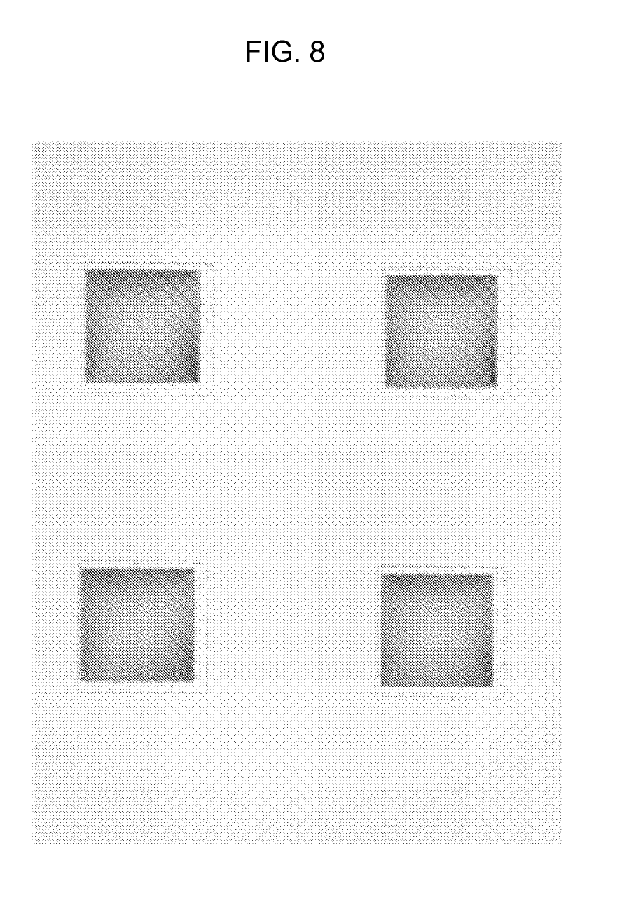

FIGS. 6-8 show photographs of an embodiment for the refractory material arrays.

1. An article comprising:
a handle chip; and
a silicon nitride membrane bonded to at least a portion of the handle chip,
wherein the silicon nitride membrane comprises an array of a plurality of silicon nitride tips extending directly from a surface of the silicon nitride membrane.

2. The article of claim 1, wherein the silicon nitride tips are nanoscopic tips.

3. The article of claim 1, wherein the silicon nitride membrane is anodically bonded to the handle chip.

4. The article of claim 1, wherein the handle chip is a pyrex handle chip.

5. The article of claim 1, wherein the handle chip comprises at least one hole region, and a portion of the silicon nitride membrane extends across the hole region.

6. The article of claim 1, wherein the handle chip comprises at least one hole region, and an elastomeric backing member for the tip array disposed in the hole region.

7. The article of claim 1, wherein the handle chip comprises at least one hole region, and a polysiloxane backing layer for the tip array disposed in the hole region.

8. The article of claim 1, wherein the tip array is totally free of cantilevers.

9. The article of claim 1, wherein the array of tips is characterized by a tip density of at least 250,000 per square cm.

10. (canceled)

11. The article of claim 1, wherein the tips of the tip array are characterized by a tip radius of about 250 nm or less.

12.-15. (canceled)

16. The article of claim 1, wherein the tip array is characterized by a tip spacing of about 1 micron to about 100 microns.

17.-18. (canceled)

19. The article of claim 1, wherein the silicon nitride membrane has a thickness of about 100 nm to about one micron.

20. (canceled)

21. A method comprising:
preparing a silicon nitride membrane comprising an array of a plurality of silicon nitride tips extending directly from a surface of the silicon nitride membrane;
preparing a handle wafer; and
bonding the silicon nitride membrane to at least a portion of the handle wafer to form an bonded tip array.

22. The method of claim 21, further comprising the step of dicing the bonded tip array.

23. The method of claim 21, wherein the bonding is an anodical bonding.

24. The method of claim 21, wherein the handle wafer is a pyrex handle wafer.

25. The method of claim 21, wherein the handle wafer comprises at least one hole region, and a portion of the silicon nitride membrane extends across the hole region.

26. The method of claim 21, wherein the tip array is totally free of cantilevers.

27. The method of claim 21, wherein the tip array is totally free of silicon tips.

28. The method of claim 21, wherein the silicon nitride is low stress silicon nitride.

29. (canceled)

30. The method of claim 21, wherein:
the handle wafer comprises at least one hole region,
a portion of the silicon nitride membrane extends across the hole region, and
the method further comprises the step of disposing an elastomeric backing member in the hole region.

31. The method of claim 21, wherein:
the handle wafer comprises at least one hole region,
a portion of the silicon nitride membrane extends across the hole region,
the silicon nitride membrane comprises a plurality of perforations surrounding at least part of the portion of the silicon nitride membrane that extends across the hole region, and
the method further comprises:
disposing an elastomeric backing member in the hole region, and
pressing the elastomeric backing member against a back surface of the silicon nitride membrane such that the part of the silicon nitride membrane surrounded by the plurality of perforations separates from a remainder of the silicon nitride membrane and attaches to the elastomeric backing member.

32. An article comprising:
an elastomeric backing member; and
an array of tips disposed on the elastomeric backing member,
wherein the tips of the array comprise a refractory material.

33. The article of claim 32, wherein the refractory material is a refractory metal.

34. The article of claim 32, wherein the refractory material is Nb, Mo, Ta, W, Ru, Ti, V. Cr, Zr, Ru, Rh, Hf, Os, or Ir.

35. The article of claim 32, wherein the refractory material is Nb, Mo, Ta, W, or Ru.

36. The article of claim 32, wherein the refractory material is Cr.

37. The article of claim 32, wherein the refractory material is W, diamond, a carbide, or a boride.

38. The article of claim 32, wherein the elastomeric backing member comprises polysiloxane.

39. The article of claim 32, wherein the tips are nanoscopic tips.

40. The article of claim 32, wherein the array is formed by a plurality of noncontinuous islands on the elastomeric backing member, each island comprising a single tip.

41. (canceled)

42. A method comprising:
providing at least one mold for a tip array comprising a plurality of mold regions for tips;
filling or coating the mold regions for tips with a refractory material, to form an array of tips comprising a refractory material; and
attaching an elastomeric backing member to the refractory material of the tips.

43. The method of claim 42, wherein the step of attaching the elastomeric backing member comprises:
disposing a liquid elastomer precursor material in contact with the refractory material of the tips; and
curing the liquid elastomer precursor material while the elastomer precursor material remains in contact with a surface of the tips.

44. The method of claim 42, wherein the elastomeric backing member comprises siloxane.

45. The method of claim 42, wherein the refractory material is a refractory metal.

46. The method of claim 42, wherein the refractory material is Nb, Mo, Ta, W, Ru, Ti, V, Cr, Zr, Ru, Rh, Hf, Os, or Ir.

47.-48. (canceled)

49. The method of claim 42, wherein the refractory material is W, diamond, a carbide, or a boride.

50. The method of claim 42, wherein the tips of the refractory material are patterned so as to form non-continuous islands, with each island covering each elastomer tip.

51. The method of claim 42, wherein the refractory material is coated to a thickness of about 250 nm to about 750 nm.

52. The method of claim 42, wherein the elastomer backing material comprises elastomer tips integral with elastomer backing.

53. A method comprising:
providing the article of claim 1,
disposing at least one patterning composition on the tip array,
transferring the ink from the tip array to a substrate surface.

54. A method comprising:
providing the article of claim 32,
disposing at least one patterning composition on the tip array,
transferring the ink from the tip array to a substrate surface.

55. An article comprising:
at least one silicon nitride tip array, wherein the tip array is substantially free of cantilevers,
at least one handle chip, wherein the tip array is bonded to the at least one handle chip.

56. An article comprising:
an elastomeric backing member; and
a silicon nitride membrane bonded to at least a portion of the elastomeric backing member,
wherein the silicon nitride membrane comprises an array of a plurality of silicon nitride tips extending directly from a surface of the silicon nitride membrane.

57. The article of claim 56, wherein the silicon nitride tips are nanoscopic tips.

58. The article of claim 56, wherein the array of tips is characterized by a tip density of at least 100,000 per square cm.

59.-60. (canceled)

61. The article of claim 56, wherein the tips of the tip array are characterized by a tip radius of about 250 nm or less.

62.-65. (canceled)

66. The article of claim 56, wherein the tip array is characterized by a tip spacing of about 1 micron to about 100 microns.

67.-68. (canceled)

69. The article of claim 56, wherein the silicon nitride membrane has a thickness of about 100 nm to about one micron.

70. (canceled)
